(19) United States
(12) Patent Application Publication
(10) Pub. No.: US 2017/0136296 A1
(43) Pub. Date: May 18, 2017

(54) SYSTEM AND METHOD FOR PHYSICAL REHABILITATION AND MOTION TRAINING

(71) Applicants: Osvaldo Andres Barrera, Omaha, NE (US); Matias Emilio Molinas, Santa Fe (AR)

(72) Inventors: Osvaldo Andres Barrera, Omaha, NE (US); Matias Emilio Molinas, Santa Fe (AR)

(21) Appl. No.: 15/353,777

(22) Filed: Nov. 17, 2016

Related U.S. Application Data
(60) Provisional application No. 62/256,732, filed on Nov. 18, 2015.

(51) Int. Cl. A63B 24/00; G09B 19/00; A63B 71/06

(52) U.S. Cl. CPC A63B 24/0003; A63B 71/0622; G09B 19/003; A63B 24/0062; A63B 2071/0625; A63B 2071/0647; A63B 2220/836; A63B 2220/806; A63B 2024/0068

(57) ABSTRACT

A system comprising wearable sensor modules and communicatively connected mobile computing devices for assisting a user in physical rehabilitation and exercising. The modules comprise sensors and the mobile computing device comprises device sensors. An application operably installed in memory of the mobile computing device provides a set of step-by-step instructions to a user for wearing the sensor modules in a particular way over an anatomical part depending on an exercise to be done by the user. The application further acquires a first set of data generated by the sensors and a second set of data generated by the device sensors. It then calculates a set transformation parameters based on the first set of data relative to the second set of data to do a sensor-anatomy registration of sensors to the anatomical part while the mobile computing device is placed substantially aligned with the wearable sensors over the anatomical part.

### CROSS-REFERENCE TO RELATED APPLICATIONS

This application claims the benefit of U.S. Provisional Application No. 62/256,732, filed Nov. 18, 2015, the contents of which are incorporated herein by reference.

### FIELD OF THE INVENTION

The present invention relates to systems and methods for physical training. More specifically, the present invention is related to the use of sensor assisted systems and methods for physical training and rehabilitation.

### BACKGROUND OF THE INVENTION

Millions of people all around the world require physical rehabilitation (injured athletes, post-surgery patients, etc.). Most rehabilitation activities require repetitive exercises, where the proper temporal/special execution is the key for a faster recovery. This is also applicable for refining motions and techniques in sports (e.g. golf swing, karate moves, etc.). Common rehabilitation practice requires patients to visit the physiotherapist (PT)'s office multiple times a week, as well as exercising at home. While physical rehabilitation is mostly successful for the majority of patients, there are currently multiple issues with the overall activities that result troublesome for both, patients and healthcare providers. For example, going to the PT's office is inconvenient and time consuming. In the case of PTs overloaded with patients, they often end up supervising multiple patients simultaneously, which is stressful for the healthcare professional, and at the same time can decrease the quality of treatment for certain patients. Additionally, PTs currently must record and document patient's progress manually, which is a time consuming and inconvenient activity for most providers, and they could benefit greatly from an automatic, accurate way to perform such tasks. Regarding home exercising, patients must learn (from the PTs) how to perform each exercise, which brings up more examples of inconvenience as this can be time consuming, and confusing in many cases. Moreover, patients' compliance regarding home exercises is usually below an ideal 100%, among other reasons, as they cannot remember how to perform the exercises, and/or because of they simply lack motivation. Missing or skipping home exercises contributes to delays in patient's recovery and can diminish the overall quality of the rehabilitation program. Documentation of patient's progress (for follow ups, PT-physician communication, insurance purposes, etc.) is time consuming and inconvenient for the PT and often measurements are not accurate or consistent enough.

Attempts have been made to overcome these problems (and some others related with physical rehabilitation) from having online or offline instructional videos all the way to replacing the human physical trainer altogether by virtual trainers, cameras, motion tracking, etc. For all these alternative technologies, it is extremely important to have an accurate system for movement/motion tracking of the anatomical structure of the user and also to have a system which can guide the user to carry out a set of exercises involving one or more body parts and to provide feedback on the actions done. Proper registration of the sensors to a body part being tracked is a key aspect in getting desired results. The present day systems and methods available for sensor registration to body parts are either very complicated or not accurate or not user friendly. In case of physical rehabilitation, the user may have limitations in terms of body parts movement and, in such cases; the system must offer user friendly steps for sensor registration. At the same time, the system must have such a user interface which can provide interactive guidance and feedback to the user without necessarily needing the user to be in close proximity to the system display. The present day systems and methods for physical training do not offer effective three-dimensional visual guidance to the users. Again, most of the present day applications, network connectivity is a must as the system needs support from a remote server.

Consequently, there exists in the art a long-felt need for a system and method for imparting physical training which can overcome the above mentioned shortcoming of the prior art.

### OBJECTS OF THE INVENTION

It is, therefore, an object of the present invention to provide a system and method for physical rehabilitation and motion training.

Yet another object of the present invention to provide a system and method for real time motion tracking of anatomical parts through wireless sensors.

Another object of the present invention is to provide a system and method for easy registration of sensors to anatomical parts of a user for motion tracking.

Yet another object of the present invention is to provide a highly accurate sensor calibration process.

Still another object of the present invention is to provide a method for registering wearable sensors to body parts using an external device.

Another object of the present invention is to provide a highly interactive user interface for physical rehabilitation and motion training.

Yet another object of the present invention is to provide a user interface for multidimensional display of instructions and feedback for physical rehabilitation and motion training.

A further object of the present invention is to provide a user interface which requires minimal physical contact from the user for receiving instructions.

Still another object of the present invention is to provide a system and method for real time localized processing of physical rehabilitation and motion training data, which can work as a standalone system and does not require network connections with other remote systems or servers.

Another object of the present invention is to provide one or more views of the movements of a particular anatomical part of the user being monitored for physical rehabilitation and motion training.

A further object of the present invention is to provide a system and method for monitoring of an anatomical part of a user, allowing visualization from multiple views and various angles and different distances.

Yet another object of the present inventions is to provide a smart virtual camera which can be auto-controlled or controlled by the user or by a third party for obtaining optimum views of one or more anatomical parts of a user for physical rehabilitation and motion training.

Another object of the present invention is to provide a system and method for identifying location and orientation of a wearable sensor based on motion of the body part to which it is attached to or based on type of exercise selected.

A further object of the present invention is to provide feedback to the user in terms of physical stimulus against correct or wrong motion of an anatomical part.

Yet another object of the present invention is to provide a system having contextual awareness of the anatomy of the user based on the context and the exercises selected.

Still another object of the present invention is to provide a system and method for calibration of sensors with the help of a mobile computing device.

Details of the foregoing objects and of the invention, as well as additional objects, features and advantages of the invention will become apparent to those skilled in the art upon consideration of the following detailed description of the preferred embodiments exemplifying the best mode of carrying out the invention as presently perceived.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention is directed to a sensor assisted physical training and rehabilitation system and method. The system, hereinafter referred to as Smart Trainer, comprises one or more sensors (custom made as well as some existing commercial products such as smart watches, e.g. Apple Watch, Samsung-Gear 2, etc. and/or smart phones could also be used as ‘sensors’) which a user can wear on a body part to accurately capture and pre-process motion, a mobile computing device (such as a smartphone), an application or app (Android, Windows, iOS or any other operating system based) operably installed in the mobile computing device which provides a unique experience, through real time guidance with 2D and full 3D graphical user interface (GUI) and a smart UX/UI, audio-visual and tactile instructions/feedback. The system can further comprise an optional back-end cloud infrastructure implemented for data storage, statistical analysis, neural networks and data mining. It can also implement an optional web-based application for accounts managements.

The Smart Trainer uses the sensors to dynamically obtain position, orientation, and motion parameters (e.g. speed, accelerations, etc.) of the user's body parts, and analyzes the error or deviations of each joint, limb, part, etc. compared to a predefined sequence of movements. In addition to the raw value collected from sensors, Smart Trainer uses a calculus and prediction engine to estimate the range of motion, acceleration, force, metabolism, calories and activity of the main muscle groups involved in the exercise. Using some or all of these parameters, the Smart Trainer presents useful information to the user in real-time (text, numbers, color coded parameters, 2D and 3D graphics, audio, tactile indication etc.) to show users how to improve their movements, in the way a coach or health care professional would do, but based on quantitative analysis as opposed to expert opinion alone.

The Smart Trainer system provides users not only contextual smart help to control their performance during physical rehabilitation but it is also applicable to other types of physical activities (e.g. sports, fitness, physical re-habilitation, etc.). It takes into account the type of exercise that the user is performing (e.g. stretching, jogging, weight lifting, squatting, flexing, etc.) as well as body and limbs' position/orientation, movements, and acceleration.

The Smart Trainer system can behave as an expert (a physician, PT or a personal trainer, depending on the type of use) assessing and indicating corrections in a similar way a person would do, based on its capability of changing the virtual view of a 3D scene/rendering, showing/hiding tools and graphics, and providing custom guides to show the correct posture and movements versus the user's real posture and movements. The Smart Trainer also shows virtual 3D paths in the virtual scene to teach and to guide the user to the next step of the exercise.

The Smart Trainer system tracks in 3D body joints and parts, using gyros, accelerators, and compass (9 degree of freedom sensors) and integrating (fusion) all values through data fusion. The Smart Trainer system aims to help teaching, guiding, correcting, and documenting users' movements in real time, for health and fitness applications. Moreover, the Smart Trainer system behaves as a smart assistant that allows doing all that, showing the most useful information for each instance, in a smart way, without requiring user interaction while the user performs any kind of exercise or movement in any kind of activity.

The Smart Trainer system enables a user to decrease the level of attention the user needs to pay to the user interface while carrying out an exercise. The Smart Trainer helps the user to follow directions on how to perform an exercise (motion or combination of movements) by providing an intuitive way (3D and/or 2D and/or audio and/or tactile) without needing to physically reach for any conventional system-input type interface.

One exemplary non-transitory computer-readable storage medium is also described, the non-transitory computer-readable storage medium having embodied thereon a program executable by a processor to perform an exemplary method for assisting a user in physical rehabilitation and exercising. The exemplary program method describes attaching a sensor module over an anatomical part of the user. The wearable sensor modules comprise one or more sensors and are configured to acquire and transmit a first set of data generated by the sensors. The program method further describes processing a second set of data acquired from the sensors included in the mobile computing device and to register the sensors of the sensor modules to the anatomical part of the user after calculating a matrix/transformation of the data acquired from the sensor modules relative to the data acquired from the mobile device sensors. The mobile computing device should be positioned substantially aligned with the anatomical part of the user. The program method also describes determination of position, orientation and motion of the anatomical part being tracked and provides visual, audible and tactile instructions to carry out the exercise steps correctly.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

In order to describe the manner in which features and other aspects of the present disclosure can be obtained, a more particular description of certain subject matter will be rendered by reference to specific embodiments that are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 illustrates a block diagram of a sensor module in accordance with an embodiment of the present invention;

FIG. 2 illustrates a block diagram of a mobile computing device in accordance with an embodiment of the present invention;

FIG. 3 illustrates exemplary modules of the mobile application in accordance with an embodiment of the present invention;

FIG. 4 illustrates a general architecture of the system of physical rehabilitation and motion training that operates in accordance with an embodiment of the present invention;

FIG. 5 illustrates an exemplary method of placing mobile computing device and sensor module relative to each other over an anatomical part of a user in accordance with an embodiment of the present invention;

FIG. 6A illustrates another exemplary method of placing a mobile computing device with respect to a position of a sensor worn over an anatomical part of a user in accordance with an embodiment of the present invention;

FIG. 6B illustrates yet another exemplary method of placing a mobile computing device with respect to a position of a sensor worn over an anatomical part of a user in accordance with an embodiment of the present invention;

FIG. 7A illustrates a device for positioning a mobile computing device in a desired way over a body part in accordance with an embodiment of the present invention;

FIG. 7B illustrates the device of FIG. 7A holding a mobile computing device in accordance with an embodiment of the present invention;

FIG. 7C illustrates the device of FIG. 7A holding a mobile computing device in a desired way over a body part in accordance with an embodiment of the present invention;

FIG. 8A illustrates an exemplary scenario showing a user and a location of one virtual camera;

FIG. 8B illustrates an exemplary screen of the GUI with a model of the user as rendered by the virtual camera;

FIG. 9A illustrates a virtual camera focusing on a particular anatomy of a user and FIG. 9B illustrates the corresponding view of the anatomy on the GUI in accordance with an embodiment of the present invention;

FIG. 9C illustrates a virtual camera focusing on another anatomical part of a user and FIG. 9D illustrates the corresponding view of the anatomy on the GUI in accordance with an embodiment of the present invention;

FIG. 10 illustrates a plurality of screens of the GUI showing different views of the user or anatomy of the user which are being dynamically tracked by a virtual camera in accordance with an embodiment of the present invention;

FIG. 11 illustrates an exemplary screen of the GUI displaying virtual trajectories that the user should follow when performing an exercise in accordance with an embodiment of the present invention;

FIG. 12 illustrates an exemplary screen of the GUI showing the error occurred during an exercise with respect to current position of the user's body part and the desired body part position along with the desired movement trajectory required to fix the faulty movement in accordance with an embodiment of the present invention;

FIG. 13 illustrates an exemplary gesture recognition command in accordance with an embodiment of the present invention; and

FIG. 14 illustrates an exemplary screen of the GUI showing contextual awareness feature in accordance with an embodiment of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

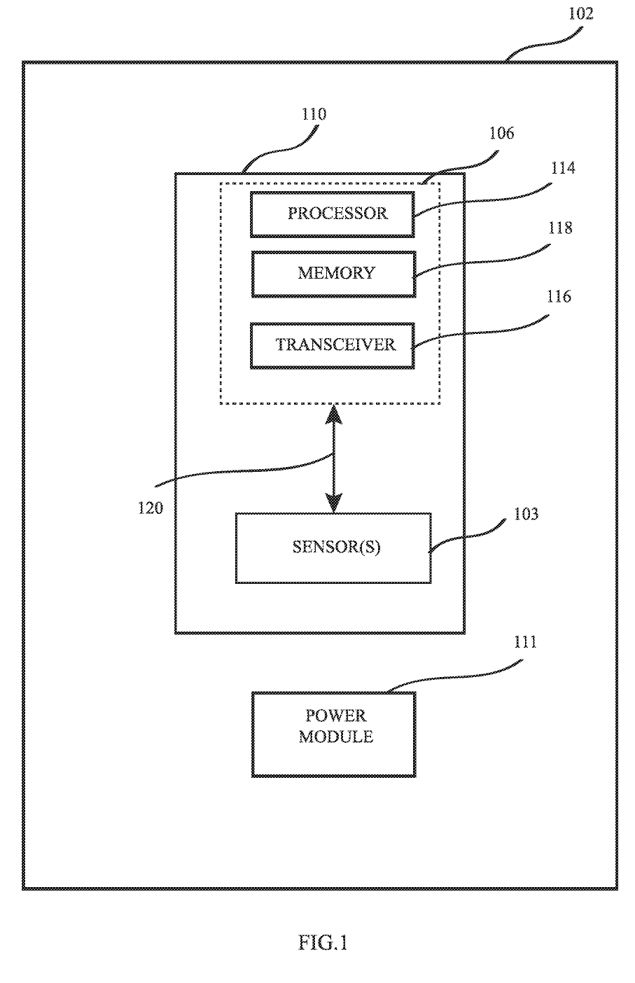

FIG. 1 illustrates a block diagram of the various components of a sensor module 102 in accordance with an embodiment of the present invention. In a preferred embodiment, the sensor module 102 referred hereinafter is a wearable sensor module. The sensor module 102 comprises one or more software and hardware modules such as one or more sensors 103, a power module 111 and a transmitter/processing module 106. In some embodiments, the sensor module 102 may further comprise one or more stimulators for providing feedback or indication to the wearer against a correct or wrong movement of body part. Examples of stimulators include, but are not limited to, vibrators, screen, lights, LEDs and any other device which can stimulate the muscles directly. In one embodiment of the present invention, the one or more sensors 103 are active sensors powered by a battery (power module 111). In another embodiment of the present invention, the one or more sensors 103 are passive sensors which do not need external power. Examples of one or more sensors 103 include, but are not limited to, accelerometer, gyroscope, Micro-Electro-Mechanical Systems (MEMS) sensors, digital compasses, magnetometers, inertial modules, pressure sensors, humidity sensors, capnometer, heart-rate meter, microphones and temperature sensors, etc. It is to be noted that, any number of sensors 103 may be used in the sensor module 102, depending upon the requirement. The sensor module 102 or the sensors 103 can be custom built in accordance with embodiments of this invention or those can be presently available devices such as smart watches, smart phones, or any device that implements a reliable position/orientation reading and are wirelessly accessible. In a preferred embodiment, the sensor modules 102 can provide 9D (9 degree of freedom) sensor fusion functionality for position/orientation calculations.

Still referring to FIG. 1, the transmitter/processing module 106 may comprise at least one processor 114, at least one transceiver 116 and at least one memory 118. The various components of the sensor module 102 may be mounted on a printed circuit board (PCB) 110. The power source 111 referred to herein includes, but not limited to, a battery 111. The processor 114 and the memory 118 may be any form of processor or processors, memory chip(s) or devices, microcontroller(s), and/or any other devices known in the art. The battery 111 supplies power to the processor 114 and, optionally to the sensor 103. The battery 111 may be rechargeable which can be charged by an external power source, or in alternative embodiments, it may be replaceable. Other devices or systems known in the art for supplying power may also be utilized, including various forms of charging the battery 111, and/or generating power directly using piezoelectric, or other devices.

For the sake of explanation let us take a situation where a person is wearing one or more sensor modules 102 of the present invention. The one or more sensors 103 of the sensor module 102 are configured to send signals to the transmitter/processing module 106, transferring the values of the properties sensed by the one or more sensors 103. The data from the one or more sensors 103 can be collected by the processor 114. The connection between the module 102 and the mobile computing device 202 (e.g. the mobile phone, tablet, etc) is achieved though the transmitter/processing module 106, and it may be through electrical connector(s), but more often implemented through wireless transmission. Wireless transmission referred to herein includes, but not limited to, Bluetooth, BLE (Bluetooth low energy), WiFi and Zigbee etc. For non-wireless mode of signal transmission between the one or more sensor modules 102 and the mobile computing device 202 (e.g. smart phone), the transmitter/processing module 106 can use different types of insulated flexible wire connections.

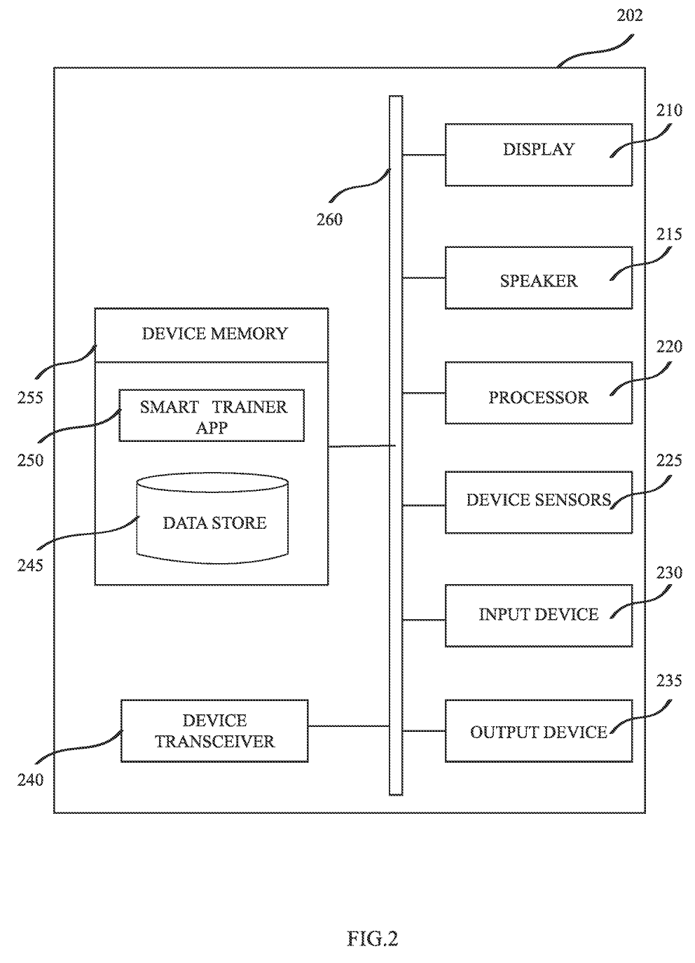

FIG. 2 shows general architecture of a mobile computing device 202 that may be utilized along with the sensor module 102 of the present invention. Examples of mobile computing device 202 include, but not limited to, smart phones, tablets, smart watches, smart glasses, etc. In some embodiments, the mobile computing device 202 may be custom built electronic device for the purpose of the present invention. As illustrated in FIG. 2, the mobile computing device 202 of this embodiment is a smart phone that includes an app 250 installed thereupon. The application or “app” is a computer program/software that may be downloaded and installed using methods known in the art. Hereinafter, the app 250 is referred to as Smart Trainer app 250.

The Smart Trainer app 250, custom built for the present invention, enables one or more persons to do various tasks related to physical rehabilitation and motion training. Examples of tasks carried out by the Smart Trainer app 250 includes, but are not limited to, facilitating calibration of the one or more sensors 103, registration or association of the one or more sensors 103 to an anatomical part, tracking of the position/orientation of the one or more sensors 103, providing guidance and feedback for physical rehabilitation and motion training and communication with one or more other mobile computing devices and/or computers through a local or wide area network.

As illustrated in FIG. 2, the mobile computing device 202 may include various electronic components known in the art for this type of device. In this embodiment, the mobile computing device 202 may include a device display 210, a speaker 215, a computer processor 220, one or more device sensors 225, a user input device 230 (e.g., touch screen, keyboard, microphone, and/or other form of input device known in the art, or custom modules for modular mobile devices like Google's project ARA that can implement for example muscle and nerve activity acquisition), a user output device 235 (such as earbuds, external speakers, and/or other form of output device known in the art, or custom modules for modular mobile devices like Google's project ARA that can implement for example muscle and nerve stimulation), one or more devices transceiver 240 for communication, a device memory 255, the Smart Trainer app 250 operably installed in the device memory 255, a local data store 245 also installed in the device memory 255, and a data bus 260 interconnecting the aforementioned components. For purposes of this application, the term “transceiver” is defined to include any form of transmitter and/or receiver known in the art, for cellular, WIFI, radio, and/or other form of wireless or wired communication known in the art. Obviously, these elements may vary, or may include alternatives known in the art, and such alternative embodiments should be considered within the scope of the claimed invention.

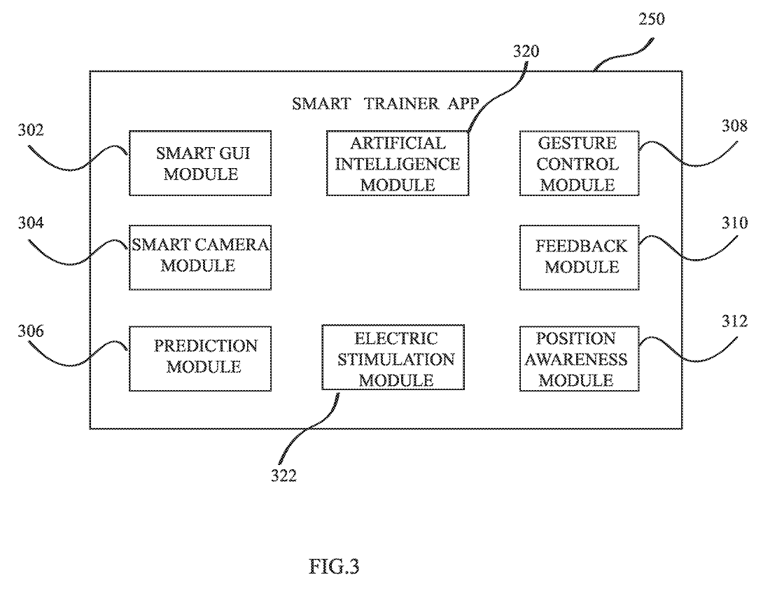

Reference to FIG. 3, the Smart Trainer app 250 comprises one or more software modules such as a smart graphical user interface (GUI) module 302, a smart camera module 304, a prediction module 306, a gesture control module 308, a feedback module 310, a position awareness module 312, an artificial Intelligence module 320 and an electric stimulation module 322. The smart GUI module 302 provides a smart GUI on the display 210 of the mobile computing device 202 and/or on an external output device 406 (such as on a TV). The Artificial Intelligence module 320 involves analyzing motion of body parts (e.g. leg, thigh, hip, etc.) in (semi) real-time and assisting/guiding users on how to correct/improve body movements, helps to calculate real-time 3D biomechanics parameters, range of motion, acceleration, force, type and amount of work, and metabolism of the muscular groups involved in the motion described. This module can work either connected or disconnected to the web so as to either operate on the local system, or process data on a remote server. Finally, Electric stimulation module 322 specializes in driving custom hardware/firmware components for modular mobile devices (e.g. Google's project ARA) that can implement, for example, muscle and nerve stimulation, or muscle and nerve activity acquisition.

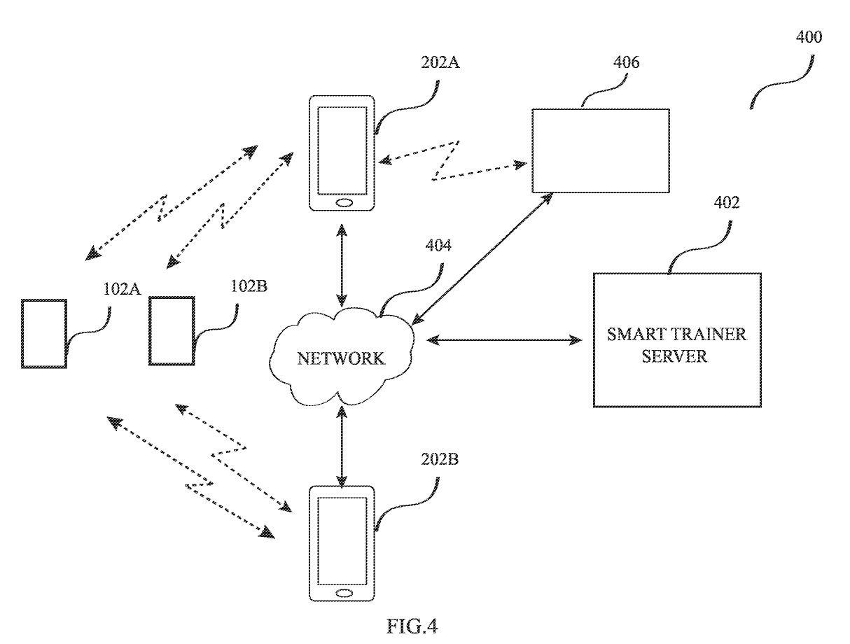

FIG. 4 illustrates a general architecture 400 of the present invention hereinafter referred to as Smart Trainer system 400. The Smart Trainer system 400 comprises one or more sensor modules 102 (two such sensor modules 102A and 102B are shown in FIG. 4), one or more mobile computing devices 202 (FIG. 4 shows two such devices 202A and 202B, e.g. one could be the user's phone, and the other therapist/trainer tablet), an optional computational device 402 performing as a remote server (hereinafter referred to as Smart Trainer server 402), a network 404 and, optionally, one or more external output devices 406. As used herein, the term “network” generally refers to any collection of distinct networks working together to appear as a single network to a user. The term also refers to the so-called world wide “network of networks” i.e. Internet which is connected to each other using the Internet protocol (IP) and other similar protocols. Additionally, the inventive idea of the present invention is applicable for all existing cellular network topologies or respective communication standards, in particular GSM, UMTS/HSPA, LTE and future standards. In a preferred embodiment, the communication between the one or more sensor modules 102 and the one or more mobile computing devices 202 occurs wirelessly. Linking of the different components in 400 includes peer-to-peer connections. Examples of wireless technology include, but not limited to, Bluetooth, WiFi, Zigbee etc.

The remote server 402 includes an application server or executing unit and a data store. The application server or executing unit further comprises a web server and a computer server that can serve as the application layer of the present invention. It would be obvious to any person skilled in the art that, although described herein as the data being stored in a single data store with necessary partitions, a plurality of data stores can also store the various data and files of multiple users. The Smart Trainer server 402 can provide facilities such as data storage, statistical analysis, neural networks and data mining. It also implements an optional web-based application for user account management. In some embodiments, the functions of Smart Trainer server 402 can be implemented in a cloud computing environment.

Reference to FIG. 4, the system 400 can work in different combinations of the components shown as per requirement and availability. The system can dynamically select how to present the information and feedback to the user (about the body position, sequence of movement to follow, errors or deviation, suggested actions, available commands, etc.). Such selection is performed based on what step into the exercise sequence the user is in as well as on the availability and dimension/specification/capability of the components of the system 400 such as the mobile computing device 202, the external output devices 406 (e.g. smart TVs, audio devices, etc.). For example, smaller screens (smart watches) would display 1 dimensional (labels and values) graphics (instruction/guidance/feedback and/or 2D graphics), while larger devices (bigger smartphones, tablets, TVs, etc.) would present more powerful 3D graphics. Larger and more powerful devices (202 or 406) may include 3 modes of visualization—(1) Exercise sequence and actual body position, including information about muscular activity and neural control, (2) Smart training 3D advices, showing error and corrective actions suggested, and (3) Fusion, both of above options fused.

Examples of different configurations supported by the Smart Trainer system 400 include, but are not limited to—
a. Two wearable sensor modules 102 for body member orientation detection, one smart phone 202 with orientation sensor in the body trunk and headphones to provide sound feedback about the error.
b. Two wearable sensor modules 102 for body member orientation detection and one smart phone 202 with orientation sensor in the body trunk, headphones and a smart watch 406 to provide sound feedback and 1D and 2D notifications in the wrist about the sequence of exercise performed, the error in the execution and the actions to correct movements.
c. Three or more wearable sensor modules 102 for body member orientation detection, one smart phone 202 to visualize and broadcast to TVs 406 information in 2D and/or 3D about the exercise sequence, the muscle activity, the neural control, the error and the suggested corrections in real time.

The sensor modules 102 are identified by the mobile computing device 202 in a number of ways. Examples of sensor module identification includes, but are not limited to, identification based on user input, identification based on color coding, bar-coding of the sensors (so that each one has a pre-defined position), identification based on motion pattern detection for each sensor corresponding to an exercise and identification based on detection of the motion pattern of each sensor even without defining the exercise.

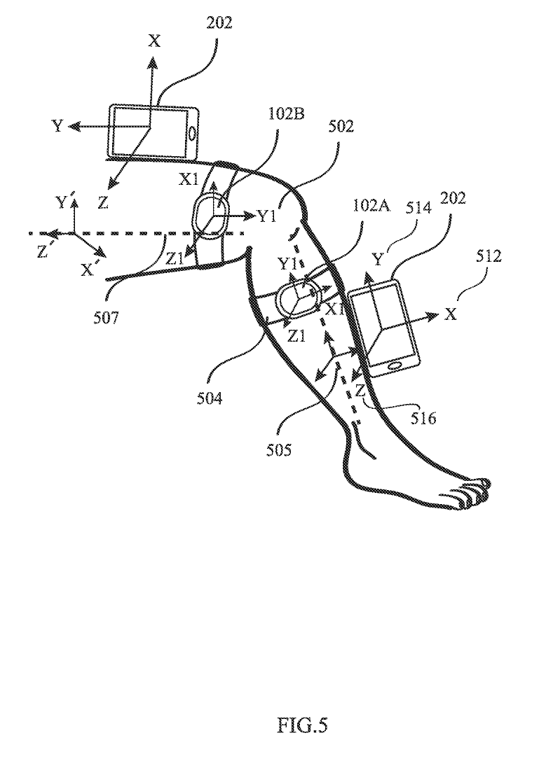

In a preferred embodiment, the smart GUI on the mobile computing device 202 provides step-by-step directions/guidance to the user for wearing the sensor module 102 in a particular way which may vary depending on the exercise to be done. The optimum nominal place for the sensor module positioning depends on the application and the part of the anatomy to be tracked. For example, for an exercise involving leg 502 of a user, the smart GUI instructs the user to put sensor modules 102A and 102B in the positions as shown in FIG. 5. It should be noted that, although, two sensor modules 102A and 102B are shown worn in FIG. 5 by the user, only one sensor module or more than two sensor modules can also be used to achieve the desired results in some other embodiments. The modes of instructions given by the smart GUI include 2D/3D visual instructions, audible instructions, tactile instructions provided through the output device 235 of mobile computing device 202.

Once the one or more sensor modules 102 are attached to an anatomical part, the smart GUI provides further instructions for facilitating registration/association of the one or more sensor modules to the anatomical part to which the one or more sensor modules are attached to. Correct spatial interpretation of information from these sensor modules requires knowledge of their position and orientation (that is, their pose) in a frame of reference coordinate system. The task of determining the sensor pose relative to the body part pose is called sensor registration and it amounts to estimating a plurality of parameters that define the coordinate transformation locating the sensor coordinates. A sensor registered to an anatomical part i.e. a sensor-anatomy registration allows tracking the motion of the anatomical part from the data acquired by the sensor registered to the anatomical part.

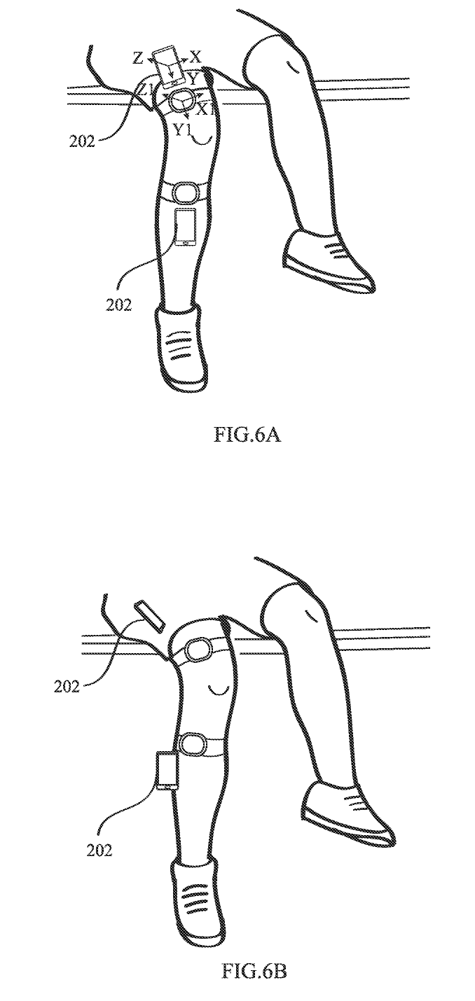

In a preferred embodiment, the present invention enables convenient and accurate sensor-anatomy registration using a registration by reference method wherein the mobile computing device 202 is required to be positioned substantially aligned with the sensor module over the anatomical part of the body of a user which needs motion tracking. The device sensors 225 of a mobile computing device are generally configured to obtain readings with respect to an XYZ coordinate system 512, 514 and 516 of the device. The coordinate-system of a mobile computing device can be defined relative to the screen of the device in its default orientation as shown in FIG. 5. The X axis 512 can be the horizontal reference to the base of the device 202, the Y axis 514 can be vertical and the Z axis 516 can point towards the outside of the front face of the screen. Preferably, for the registration of each position of the sensor module, as shown in FIG. 5, the mobile computing device 202 should be positioned with its virtual coordinate-system (X-axis, Y-axis, Z-axis) aligned as close as possible with that of the anatomical part to be tracked, explained for each case, for example, by the smart UI, user's manual, etc. While not all axes must coincide (e.g. X-X′, Y-Y′, Z-Z′), it is important that each axis on the device's sensor coincides with one axis of the anatomy as shown in FIG. 6A and FIG. 6B (e.g. X-Z′, Y-(−Y′), Z-X′), where X′, Y′, and Z′ represent the coordinate system of each anatomical structure (along axes 505 and 507, for example), each defined and communicated to the user (e.g. user manual, figures, etc.). Moreover, preferably, but not necessarily, for each position of the sensor module, as shown in FIG. 5, the sensor module should be positioned with its virtual coordinate-system (X1-axis, Y1-axis, Z1-axis) 512, 514, and 516 aligned with that of the anatomical part to be tracked. The Smart Trainer App 250 collects the data provided by the device sensors and by the sensor modules. For example, reference to FIG. 5, for each position of the sensor modules 102A and 102B, the Smart Trainer App 250 installed on the mobile computing device 202 acquires a first set of sensor data from the sensor module and a second set of data from the device sensors. As soon as the Smart Trainer app 250 acquires sufficient amount of data for carrying out the necessary calculations, it instructs the processor 220 to provide audible/visible/tactile notifications. The Smart Trainer app 250 system performs appropriate calculations (math/algebra/vectors) with the help of processor 220 to find out the relative matrix/transformation parameters of the data acquired from the sensor modules relative to the device 202 sensors' data. At this point, assuming that the position of the mobile computing device in 202 is aligned with the anatomy to track, the system will have enough information to calculate the orientation (and location) of the limb just from the device sensor's data (as well as the matrix/transformation parameters calculated before). This operation should be repeated for each anatomy-sensor module pair required for the exercise.

There could be multiple ways available for aligning the virtual coordinate system of the mobile computing device 202 with respect to a sensor module. For example, as shown in FIG. 6, the mobile computing device 202 can be placed flat with the Y-axis of the device 202 lying along the main axis of the body part (here the leg and thigh shown in FIG. 6A) that is being registered.

While the information from either of the methods shown in FIG. 5 and FIG. 6A would give a good approximation of the sensor-anatomy registration, it can be improved with a bit of redundancy. This is achieved by following a similar process of placing the mobile computing device 202 at a slightly different position, as indicated in FIG. 6B. Similarly, the body part being registered can be at different postures and the mobile computing device 202 can also be placed at multiple locations/orientations with respect to the body part for the sensor-anatomy registration. Additionally, the registration can also be achieved with multiple devices 202 versus anatomy positioning achieving one axis direction correspondence at the time, as opposed to all three axes directions as explained with reference to FIG. 5.

In some embodiments, after registering a sensor module to an anatomical part, with the help of the mobile computing device 202, the sensor-anatomy registration can be improved further without using any external device (not even the mobile computing device). This can be done by performing a series of known/defined movements while dynamically collecting positioning/orientation data from the one or more sensor modules and then analyzing the acquired data to obtain patterns and key information (e.g. axis of rotation, pivoting center, etc.). This method includes providing instruction to the user through the Smart GUI by the GUI module 302 of Smart Trainer app 250 to strap/clip/place/wear the sensor modules in a specific way (e.g. one sensor in the ankle and another sensor over the knee as shown in FIGS. 5, 6A and 6B) using graphics, videos, audio, etc. The Smart Trainer app 250 then asks the user to perform specific movements (e.g. swing arm, flex leg, etc., which can be displayed in the GUI) of the body parts to which the sensor modules are tied to and collects the sensor readings simultaneously. It can also include steps to request the user by the Smart Trainer app 250 to be in static positions (e.g. sitting, squatting, standing, lying down in different anatomical positions, etc.) for calculating the registration matrices.

In some other embodiments, the present invention allows sensor-anatomy registration without requiring positioning of the mobile computing device over the anatomical part with respect to the sensor module. The Smart GUI module 302 provides instructions through the GUI (GUI displayed on the mobile computing device or on TV/Computer screen etc.) to the user for positioning himself/herself (or their limbs, or body part to be tracked) in certain ways. Once the user is in proper position (detected by the Smart Trainer app 250 in different ways, like voice command, tapping on a touch screen GUI, gesture—detected by motion sensors, or simply lack of further movements), it calculates the registration matrices. The data related to the sensor-anatomy registration are stored in the data store 245 of the mobile computing device 202 or, in some other embodiments, this data can be stored in the Smart Trainer Server 402. The sensor-anatomy registration process of the present invention can be used for the initial calibration of the sensors also.

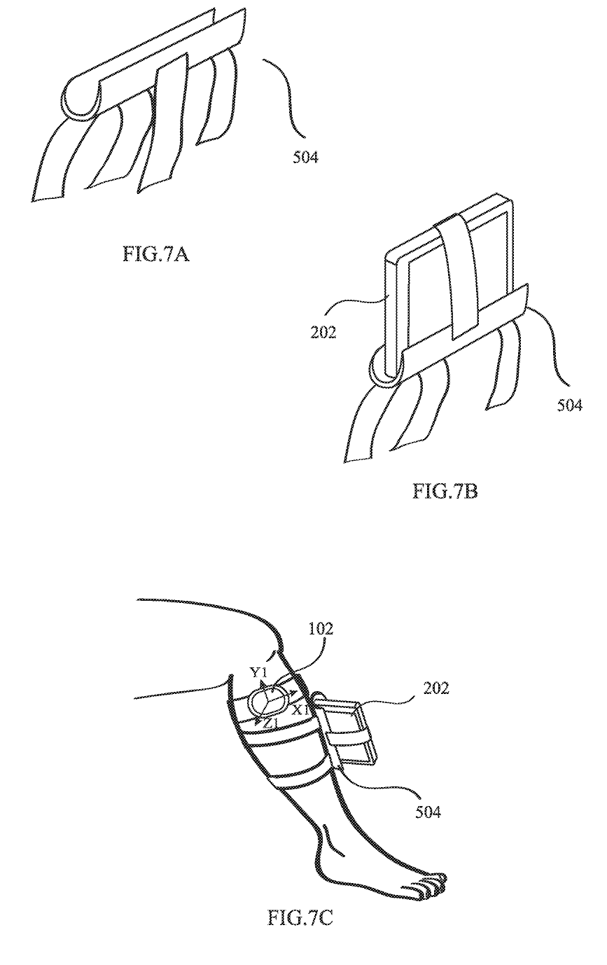

During the registration process described with reference to FIG. 5, FIG. 6A and FIG. 6B, users can hold the device 202 with their hands. Alternative, they can use a device holder 504 to ensure proper orientation and to help holding the device stable. The device holder 504 can be of any suitable shape and size which can hold a standard sized mobile computing device at a desired place and orientation. In a preferred embodiment, as shown in FIG. 7A, FIG. 7B and FIG. 7C, the device holder 504 is designed in such a way that it firmly holds a mobile computing device 202 as perpendicularly to a body part as possible to help improving the sensor registration process.

It could be difficult and inconvenient for users to reach a touch screen or keyboard while performing an exercise. In a preferred embodiment, the one or more smart modules included in the Smart Trainer app 250 of the present invention allow users to interact and control various functions of the Smart Trainer app 250 even without coming in physical contact with the user interface. For example, once the sensor-anatomy registration is over, a user can control the display and other content of the GUI through gesture control without touching the touch screen of the mobile computing device 202. The gesture control module 308 uses the data acquired from the one or more sensor modules 102 worn by a user for motion tracking to read the gestures made by the user and interpret the data into appropriate command for controlling the functions of the Smart Trainer app 250. The gesture control module 308 can detect and evaluate if the user is having trouble following the directions or the instructions for any given exercise.

In a preferred embodiment, a large set of physical exercise instructions approved by experts (e.g. physiotherapist, personal trainer, etc.) are stored in the data store 245 and/or in the Smart Trainer server 402. These instructions are used as reference parameters to provide instructions and compare movements of body part(s) and/or sequence of movements of body parts of users. Once a user selects a particular exercise, the Smart Trainer app 250 provides instructions related to the targets or goals for each exercise through the GUI.

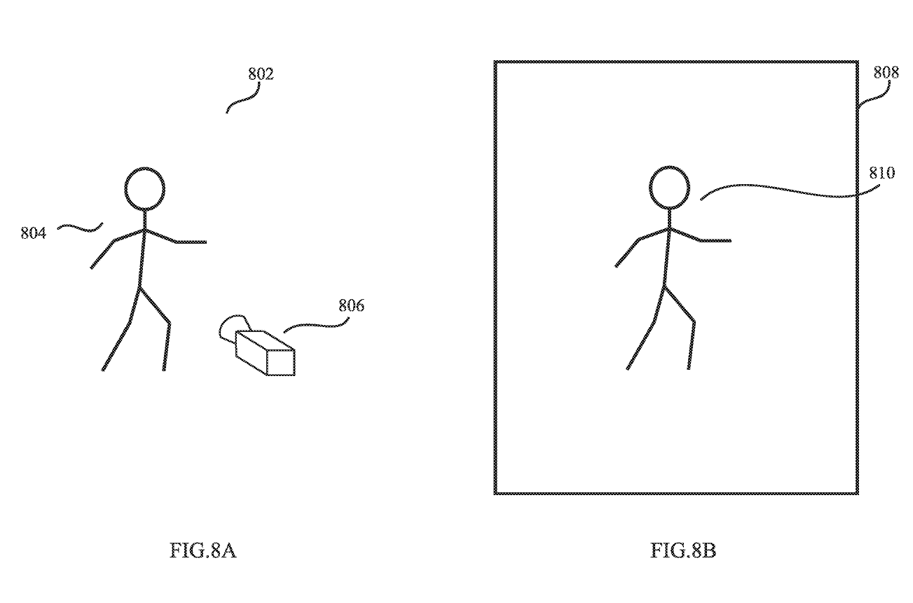

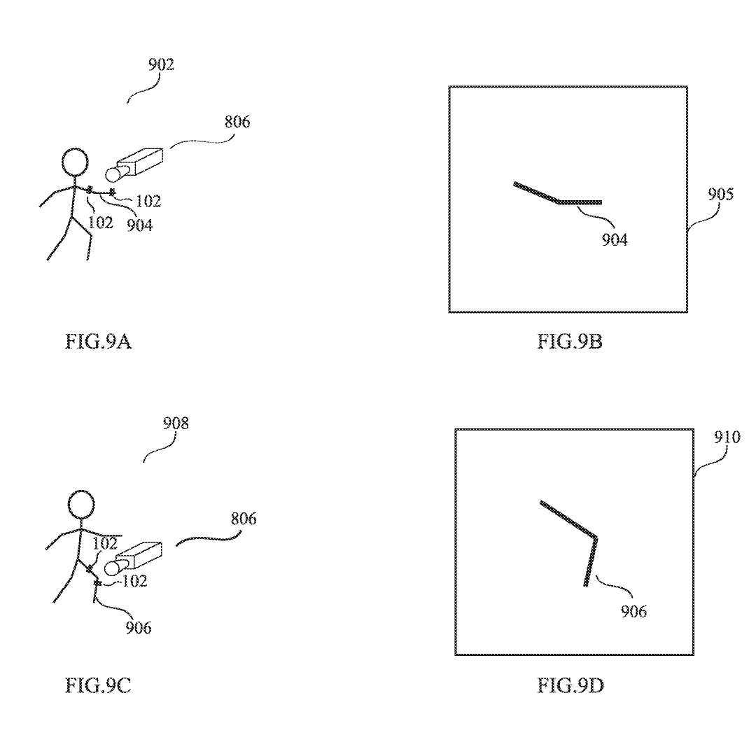

The smart camera module 304 provides a virtual camera which can render optimum view of the user as a whole and/or the anatomy being tracked, in particular, relevant to the exercise selected and presents the view(s) on the GUI as decided by the user or as per pre-set or real-time conditions. The virtual camera of the present invention can be set at any angle and focus to render 2D (2-dimensional) and/or 3D (3-dimensional) visuals of the anatomy being tracked. FIG. 8A illustrates an exemplary scenario 802 which shows user 804 being represented in 2D humanoid figure with a virtual camera 806 tracking the movements of the user 804 from one direction. FIG. 8B represents an exemplary screen 808 of the GUI which shows the full body of the user in humanoid shape 810. A user is allowed to move the virtual camera 806 in any direction and at any angle by gesture control (also possible by verbal or touch command) if the user wants to see a particular portion of the anatomy being tracked. At the same time the virtual camera module 304 can also locate/move the virtual camera 806 in order to follow the body movements and show the targets from the optimal position and angle, manage the zoom and add contextual information to show errors and advises through the GUI. For example, reference to FIG. 9A, if the user is wearing one or more sensor modules 102 on the hand 904 and the selected exercise involves movement of the hand 904 as shown in example 902, then the virtual camera 806 will focus on the hand 904 when needed or when the sequence comes. Screen 905 in FIG. 9B shows hand 904 of the user on the GUI when the virtual camera 806 focuses on the hand 904 as shown in FIG. 9A. Similarly, as per user instruction or as per the settings, the virtual camera 806 can focus on the leg 906 of the user as illustrated in example 908 of FIG. 9C to exclusively show the leg being tracked on the screen 910 of the GUI as can be seen in FIG. 9D. The virtual camera 806 can be further focused to show an anatomical part such as ankle, knee, wrist etc. as required.

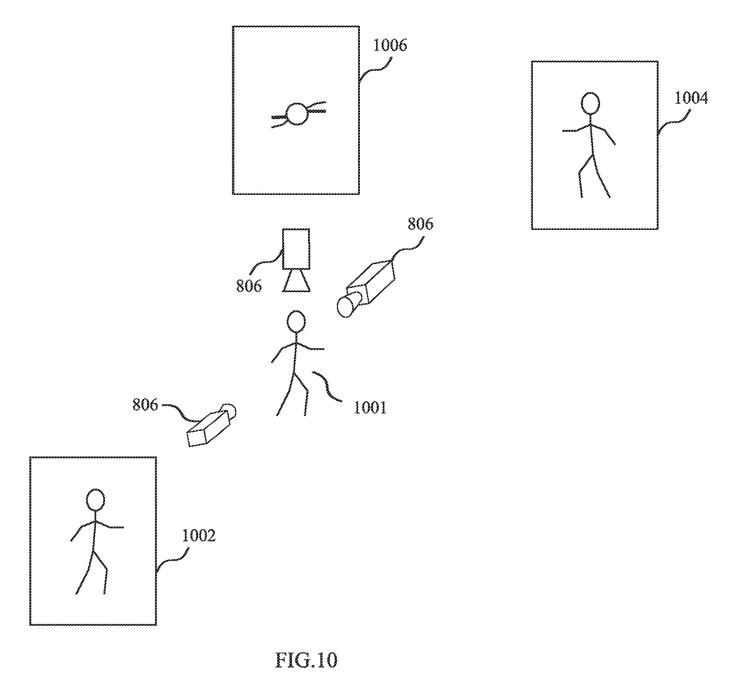

When the virtual camera 806 moves automatically as per the settings or on demand or by automatic error detections, it shows the different targets for a specific exercise which gets activated at different moments of the exercise sequence. FIG. 10 illustrates how the virtual camera 806 can render multiple views for the same posture of the user. Exemplary screens 1002, 1004 and 1006 of the GUI show different views of the user 1001 from different angles as rendered by the virtual camera 806.

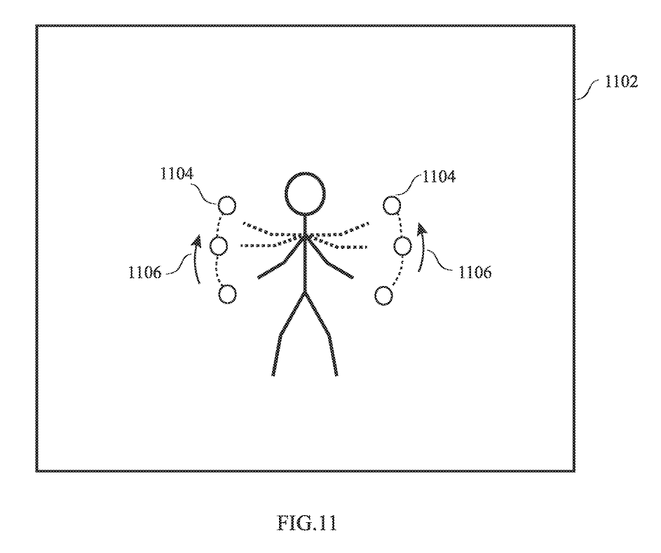

The Smart Trainer app 250 provides guidance to the user in the form various visual and audible cues. For example, reference to FIG. 11, the GUI can display a virtual trajectory 1106 that the user should follow when performing an exercise. The virtual trajectory 1106 is displayed using virtual 3D objects such as the ball 1104 augmented with a 3D scene where the user can see his/her body performing the exercises, and the goals/target that the user must reach for the next movement. When the user reaches the goal, the system hides that goal/target and shows the next one. The goals/targets are shown in 3D, for example using lines, cylinders, and semitransparent virtual spheres or balls etc. It can also show virtual objects to be reached by the user (e.g. a ball) as a motivation tool.

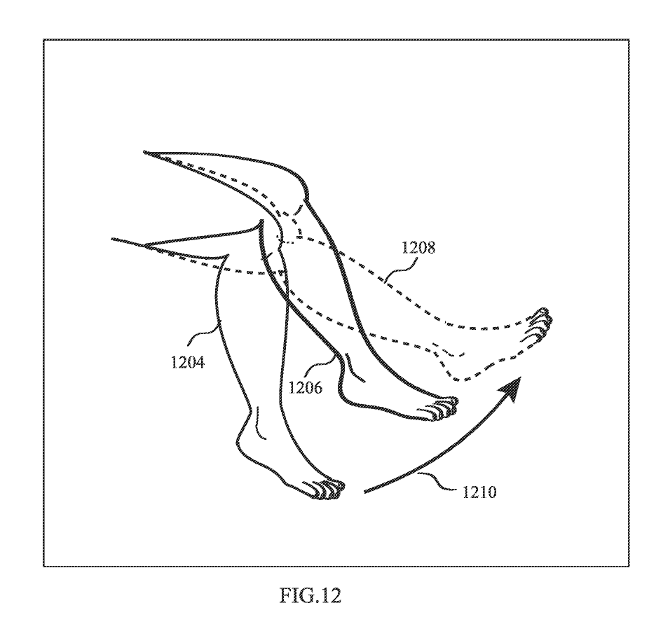

In a preferred embodiment, the feedback module 310 compares actual motion/movement/position of an anatomical part being tracked with an ideal motion/movement/position and provides visual and/or audible instructions for correcting the motion/movement/position on finding an error/deviation. By way of example, reference to FIG. 12, to show the errors (deviations in actual user's movements relative to prescribed path and/or position and orientation) during exercises, the Smart Trainer app 250 shows the real body part position models 1204 and 1206 of the user doing an exercise and the desired body position model 1208 and the desired movement trajectory 1210 (in 2D or in 3D) required to fix the movement. Each exercise has a set of goals, some of which are time independent while others are specific for certain moment in the sequence. The Smart Trainer uses additional information, like semitransparent 3D shapes and 3D trajectories to provide information about the goal, the current movement execution and the error. Likewise, for each step of an exercise sequence, the Smart Trainer app 250 can provide visual guidance in 2D and/or 3D and also provide feedback to the user. In some embodiments, the GUI also displays contextual and symbolic information such as arrows, numbers and text indicating angles, distances, speed, warning sign when a wrong movement is detected, details of an error and instruction for corrective measure and/or color codes to indicate right/wrong movements/positions.

The models (desired 1208 & measured position/motion 1204, 1206 in FIG. 12) can be represented and differentiated by any combination including (but not limited to) the following: color (e.g. red vs green), opacity (more or less transparent representation of the 3D model), model representation (e.g. wire-mesh, solid, shiny, dull, profile, outlines, etc.). The parameters above can dynamically change based on the magnitude of error (ideal vs measured position). For example, the color of a model can vary from a pale pink for a small error, to a brighter red for a larger error. Similarly, opacity/transparency can vary based on the magnitude of the errors, and so on.

While the Smart Trainer app 250 can present a vast amount of information related to the user exercise execution at any time, the system only presents the user with the relevant information based on the instance of the exercise sequence (hiding, but available on demand unnecessary data/graphics). The system evaluates in real time and applies custom algorithms to determine in a smart way in what stage of the process is the user at any time, and selects what to display accordingly.

Based on the exercise type and users preferences, the system 400 can play, through output device 235 of the mobile computing device 202 and/or through the external output device 406, audio, sounds, voice messages, etc. that change dynamically based on the magnitude of error (ideal vs measured position). These audio signals can change dynamically:
a. Different patterns of sound can be used for different kind of errors (e.g. errors in different rotational direction)
b. Different pitch can be used for different magnitude of error (e.g. higher pitch for larger error).
c. Different ‘ticking’ frequency can be used for different magnitude of error (e.g. more ‘tics’ per second corresponding to larger error).
d. Dynamic and context-based voice messages.

In addition to the raw value collected from sensor modules 102, Smart Trainer app 250 uses a calculus and prediction engine (prediction module 306) to estimate a plurality of parameters such as the range of motion, acceleration, force, the metabolism, calories and activity of the main muscle groups involved in the exercise. The prediction module 306 can then provide the feedback on error and predict as to what extent the exercise execution can be improved in a current session. Using these parameters, the Smart Trainer app 250 presents useful information to the user in real-time (text, numbers, color coded parameters, 2D and 3D graphics, audible, tactile indication etc.) to show users how to improve the movements, in the way a coach or health care professional would, but based on quantitative analysis as opposed to expert opinion alone.

The Smart Trainer app 250 can perform not only analysis of the sequence of movements and their execution performance in real-time, but, additionally it can also calculate and predict physiological parameters, like the main muscle group activity and metabolism, using a local prediction engine 306, for the disconnected mode, and a more accurate prediction engine for the connected mode where it takes help of server system.

The specific muscle activity for an anatomical part of the user can be measured directly with the actual sensor modules 102 (e.g. electromyography and/or thermal sensors), or can be estimated by the (local or remote) ‘prediction engine’ 306 based on the motion/position/orientation readings acquired from the sensor modules 102. The prediction engine 306 uses neural networks and fuzzy logic for the local engine, based on training existing data (obtained from actual sensors on multiple users during neurons training), or using a deep learning based prediction engine. In both of the last two cases where prediction is used, muscle activity would present a predictable percentage error.

Using sensor-anatomy registration techniques (described above reference to FIGS. 5-7) and modeling body joints (described above reference to FIGS. 8-10), the system of the present invention estimates body joints flexion and position. Accuracy in guidance can be achieved by including additional sensors, whether real or virtual (Artificial Intelligence—A.I.) ones, to register other parameters such as muscle activity.

Virtual sensors' readings, in accordance with an embodiment of the present invention, are calculated based on the 9D motion/orientation sensor modules 102 which represent the position of body members. Theses virtual sensors provide an estimation of the specific muscles activity of the body member, the ones that are involved in the analyzed movement, the neural control, and the metabolism, based on a machine learning system trained using the same exercise, patient features and real sensors to get real training data. The sensor modules 102 provide the orientation of body parts/member using accelerometers, gyros and compass and a customized fusion algorithm. The orientation and position are translated and analyzed to anatomical coordinates. Virtual sensors provide the muscle group activity, neural control, and metabolism, using the local prediction module 306 in stand-alone mode and, optionally, using the server 402 in cloud environment if connectivity exists for more powerful processing and/or for more accurate value.

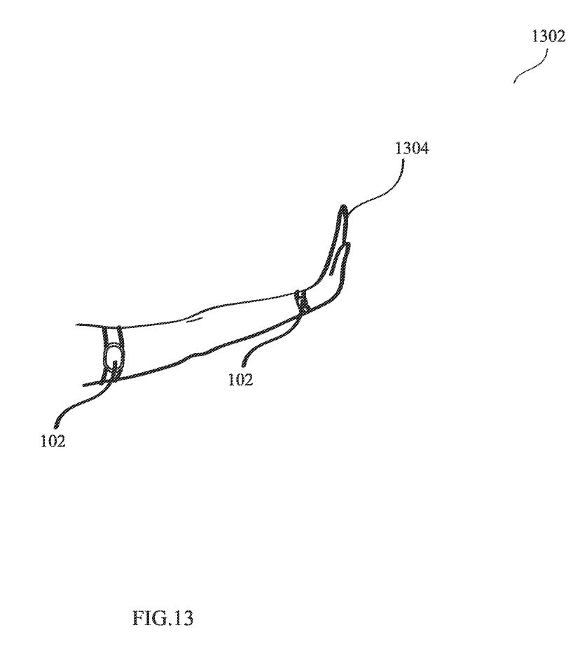

FIG. 13 illustrates an exemplary gesture 1302 made by hand 1304 of a user wearing a plurality of sensor modules 102 which can be read by the gesture control module 308. For example, the hand gesture shown in example 1302 can be used for giving the command “Stop” to the Smart Trainer app 250. Similarly, the GUI can present a list of commands corresponding to gestures recognizable by the Smart Trainer for controlling one or more functions of the Smart Trainer app 250 staying away from the GUI display. Additionally, the user can use voice commands to control the Smart Trainer app 250.

As shown in FIG. 4, the functions of physical rehabilitation and motion training system of the present invention such as acquisition and processing of data for providing guidance/feedback can be performed locally by the mobile computing device 202A of the user and/or by the mobile computing device 202B of a physical instructor without requiring internet and server kind of facilities. Additionally, the system enables transmission of audio/visual instructions to an external output device such as a TV (or Computer monitor) 406 even when there is no internet connection available. In some embodiments, the system can take help of a server 402 (in cloud computing environment or otherwise), through an internet connection for data processing, uploading parametric values and receiving values calculated on the servers.

In addition to improving and miniaturizing the control and guidance for the execution of a sequence of movements as part of a physical rehab treatment or motion exercise, the Smart Trainer system 400 can be used to track the movement/motion sequence performance and the muscle and neural control activity of the anatomy being tracked. Therefore, the system 400 can be used for training on a new program to increase force, resistance, and ability, or during different stages of a championship, or to evaluate another kind of rehab treatment, like other types of therapy including the ones that require specific medicaments.

The Smart Trainer system 400 can present the information in multiple (simultaneous or otherwise) devices, and automatically detects the number of display devices 202 and 406 (e.g. smart watch, phone, tablet, TV, etc.) and their resolution in pixels. The system 400 implements different modes for presenting the information/guidance/feedback to the user and/or a physical trainer.
Mode I: Shows/instructs/displays on the GUI how to perform the rehab exercise at each instance of the exercise sequence. The movements are dynamically rendered on screen in 3D. This 3D scene shows a virtual human (e.g. model as in FIG. 8B) performing the exercise and giving advices and contextual information about how to perform the exercise.
Mode II: Shows/instructs/displays a 3D scene with a virtual human performing the exercise as before, but now the motion of the model is synchronized in real-time with the user's movements, which are captured with the sensor modules, and processed on-board. This mode also shows deviations/errors (users real motion vs desired movements for any given exercise), and advices to the user about how to correct them as shown in FIG. 12.
Mode III: Or fusion mode. In this mode the user can see the mode I and the mode II combined or fused.

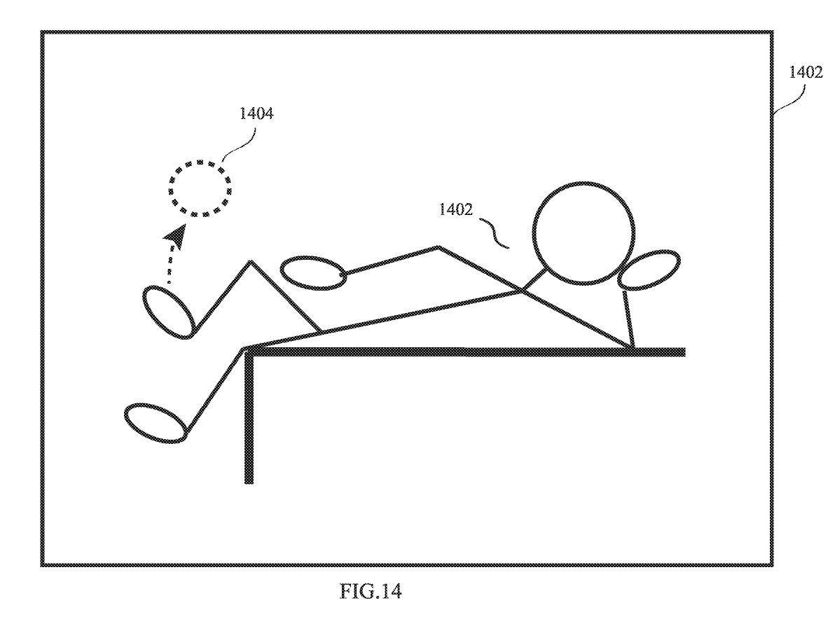

The Smart Trainer app 250 can implement a unique feature related to the position/posture of a user with respect to real world coordinates. The sensor-anatomy registration and/or calibration process enables the Smart Trainer app 250 to define the relationship between the coordinate system of the sensors worn by a user and the global coordinate system. The orientation of the anatomy of the user can be represented by an orientation matrix based on which the position/orientation of the anatomy of the user can be determined with respect to the real world coordinates. Reference to FIG. 14, the position/orientation feature, referred to as “position awareness” hereinafter, lets the Smart Trainer app to determine that the body of the user 1402 is on a substantially horizontal plan with respect to the real world coordinates and, based on this information, the app can indicate (e.g. through voice messages and/or through messages on the screen as shown by indication 1404 on GUI screen 1402) and guide the user in terms of his or her own position and orientation relative to the world (coordinate system). In other words, the app can be aware of where is UP, DOWN, RIGHT, FORWARD, etc. relative to the user.

There are multiple parameters that the user (and/or the Smart Trainer app) can dynamically change:
a. Maximum lag allowed: How much a user can fall behind in following the instructions before the system starts notifying/reporting it to the user.
b. Variable speed: How fast/slow the exercise is performed i.e. how fast the movements (the desired motion) are performed by the 3D model.
c. Auto-following: Instead of setting some speed, the system progresses with the desired movement as the user is reaching it. In other words, a user can never catch-up with the desired position as it always moves one step ahead. This allow used to perform the exercises at their own speed, focusing on quality of the movement (mainly for fine motion rehab).
d. Type of feedback presented to the user (based on 3D and 2D guidance, and sound).
e. Training: The system helps the user to learn the sequence of movements (for complex cases) before starting the exercise per-se.

In addition to the 3D rendering of the scene, the patient model, and the ‘shadow’/instructor, in some embodiments, the system implements immerse reality features like ‘Google Cardboard’. This will allow the user not only to have perspective/depth feeling, but also change the point of view (camera location) based on movements of his/her head and body.

One of the key features of this Smart Trainer system is to help increasing patients/athletes compliance. Some of the examples of the key features designed to keep the user motivated are—
Schedule: The system keeps track of the user's program, and sends messages, pop-ups and notifications about the milestones achieved, and the exercising that needs to be carried out (and its alternatives)
Punch-card: This is a visual feature that shows the overall list of objectives (e.g. range of motion, number of repetitions, etc.) that the user needs to achieve: As the user fulfills any of them, they get punched in the card.
Message board: This feature reflects encouragement messages sent by friends/contacts with whom the user decides to share his/her progress data.
Communication board (this may or may not be the same as the above): Presents messages exchanged back and forth with PT and/or physician.
Timelines: Presents graphically the milestones and progress of the user (within the established program).
3D virtual objects: The application can present virtual 3D objects (e.g. balls, obstacles, etc.) next to the human model. Then, the user can be encouraged to reach long enough (with his/her leg or arm to kick or punch a ball, or move quick enough to avoid an obstacle).
Games: Different games (both, animated and not animated) can be presented as stimulus, in which the progress or advance of the character/score/strategy is based on the number of repetitions of certain excessive, the speed in motion, the acceleration, the complexity of the motion, objectives reached, etc.
The features above can also be compatible with social media application (e.g. Facebook, Twitter, etc.).

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “affixed”, “fitted”, “attached”, “tied” are to be construed as partly or wholly contained within, attached to, or joined together, even if there is something intervening. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for assisting a user in physical rehabilitation and exercising, said method comprising:
attaching a sensor module over an anatomical part of said user, said sensor module being configured to transmit a first set of data generated by one or more sensors included in said sensor module; and
placing a mobile computing device substantially aligned with said anatomical part, said mobile computing device comprising one or more device sensors capable of generating a second set of data with respect to a coordinate system of said mobile computing device;
wherein, an application at said mobile computing device processes said first set of data and said second set of data to find out a transformation of said first set of data relative to said second set of data to calculate a position, an orientation and a motion of said anatomical part based on said second set of data acquired from said one more device sensors.

2. The method as in claim 1, wherein said application comprises a smart graphical user interface (GUI) module, a smart camera module, a prediction module, a gesture control module, a feedback module, a position awareness module, an artificial Intelligence module and an electric stimulation module.

3. The method as in claim 2, wherein said smart graphical user interface module provides a set of instructions including a plurality of two-dimensional and/or three-dimensional visual instructions, a plurality of audible instructions and a plurality of tactile instructions to said user.

4. The method as in claim 2, wherein said smart camera module provides a virtual camera capable of rendering optimum view of said user as a whole and/or of said anatomical part relevant to an exercise.

5. The method as in claim 4, wherein said virtual camera is configurable to set at a desired position and focus.

6. The method as in claim 5, wherein said desired position and focus of said virtual camera are controllable through a gesture command or a verbal command or a touch command.

7. The method as in claim 4, wherein said virtual camera moves automatically to show different targets as per sequence of said exercise.

8. The method as in claim 3, wherein said plurality of two-dimensional and/or three-dimensional visual instructions involve a display of a virtual movement trajectory on a graphical user interface as part of said set of instruction for said user.

9. The method as in claim 3, wherein an actual motion/movement/position of said anatomical part is compared with an ideal motion/movement/position to provide said set of instructions.

10. The method as in claim 3, wherein said set of instructions includes a contextual and a symbolic information.

11. The method as in claim 2, wherein said prediction module estimates a range of motion, acceleration, force, metabolism, calories and activity of a main muscle groups involved in an exercise.

12. The method as in claim 3, wherein said application determines said orientation and said position of said anatomical part with respect to a plurality of real world coordinates to provide said set of instructions.

13. A system for assisting a user in physical rehabilitation and exercising comprising:
one or more wearable sensor modules, said one or more sensor modules comprising one or more sensors;
a mobile computing device communicatively connected to said one or more sensor modules, said mobile computing device comprising one or more device sensors, a memory and a processor; and
an application operably installed in said memory of said mobile computing device that, when executed by said processor:
provides a set of step-by-step instructions to said user for wearing said one or more sensor modules in a particular way over an anatomical part depending on an exercise to be done by said user;
acquires a first set of data generated by said one or more sensors;
acquires a second set of data generated by said one or more device sensors; and
calculates a transformation of said first set of data relative to said second set of data to do a registration of said one or more sensors to said anatomical part while said mobile computing device is placed substantially aligned with said one or more wearable sensors over said anatomical part.

14. The system as in claim 13, wherein a position, an orientation and a motion of said anatomical part are determined by said application once said registration of said one or more sensors to said anatomical part is done.

15. The system as in claim 13, wherein any one axis of said one or more device sensors coincides with one axis of said anatomical part.

16. The system as in claim 13, wherein said application comprises a smart graphical user interface (GUI) module, a smart camera module, a prediction module, a gesture control module, a feedback module, a position awareness module, an artificial Intelligence module and an electric stimulation module.

17. The system as in claim 16, wherein said smart graphical user interface module provides a plurality of information including a plurality of two-dimensional and/or three-dimensional visual instructions, a plurality of audible instructions and a plurality of tactile instructions to said user.

18. The system as in claim 17, wherein one or more display devices communicatively connected to said mobile computing device are selected by said application for display of said plurality of two-dimensional and/or three-dimensional visual instructions based on type of said exercise and on the availability of said one or more display devices.

19. The system as in claim 16, wherein said smart camera module provides a virtual camera for visualization of said anatomical part from a plurality of views, from a plurality of angles and from a plurality of distances.

20. The system as in claim 19, wherein said virtual camera is controllable through a gesture command or a verbal command or a touch command for obtaining said plurality of views, said plurality of angles and said plurality of distances.

21. The system as in claim 17, wherein said plurality of two-dimensional and/or three-dimensional visual instructions include a display of a desired movement trajectory and an actual movement trajectory of said anatomical part on a graphical user interface.

22. The system as in claim 16, wherein said prediction module estimates a range of motion, acceleration, force, metabolism, calories and activity of a main muscle groups involved in said exercise.

23. The system as in claim 14, wherein said application determines said orientation and said position of said anatomical part with respect to a plurality of real world coordinates.

24. A non-transitory computer-readable storage medium having embodied thereon a program executable by a processor to perform a method for assisting a user in physical rehabilitation and exercising, said method comprising:
providing a plurality of instructions for attaching a sensor module over an anatomical part of said user, said sensor module being configured to transmit a first set of data generated by one or more sensors included in said sensor module;
receiving said first set of data from said sensor module;
acquiring a second set of data from a mobile computing device positioned substantially aligned with said anatomical part, said mobile computing device comprising one or more device sensors capable of generating said second set of data with respect to a coordinate system of said mobile computing device;
calculating a set of transformation parameters based on said first set of data relative to said second set of data to carry out a sensor-anatomy registration of said one or more sensors to said anatomical part;
tracking a position, an orientation and a motion of said anatomical part based on said set of transformation parameters; and
providing a plurality of visual, audible and tactile information to said user for correctly performing a physical exercise involving said anatomical part.
